(19) United States
(12) Patent Application Publication
(10) Pub. No.: US 2022/0131902 A1
(43) Pub. Date: Apr. 28, 2022

(54) Diameter Charging-Rule Inheritance Support

(71) Applicant: Parallel Wireless, Inc., Nashua, NH (US)

(72) Inventor: Shivani Mehrotra, Pune (IN)

(21) Appl. No.: 17/509,199

(22) Filed: Oct. 25, 2021

Related U.S. Application Data
(60) Provisional application No. 63/104,571, filed on Oct. 23, 2020.

(51) Int. Cl. H04L 29/06; H04L 29/08

(52) U.S. Cl. CPC H04L 63/20; H04L 69/329

(57) ABSTRACT

Systems, methods and computer software are disclosed for providing Diameter charging-rule inheritance support. In one embodiment a method is disclosed, comprising: provisioning, using an inherit-Charging Rules attribute value pair (AVP), dynamic rules at a Policy Charging and Enforcement Function (PCEF), wherein the inherit-Charging Rules AVP includes an AVP header, an associated session and at least one of a charging rule name, an exclude charging rule name, an exclude charging rule base name, and an AVP; and wherein the AVP inherits policy and charging control (PCC) rule definitions referenced in an Association-Session AVP.

### CROSS-REFERENCE TO RELATED APPLICATIONS

This application claims priority under 35 U.S.C. § 119(e) to U.S. Provisional Pat. App. No. 63/104,571, filed Oct. 23, 2020, titled “Diameter Charging-Rule Inheritance Support” which is hereby incorporated by reference in its entirety for all purposes. This application also hereby incorporates by reference, for all purposes, each of the following U.S. patent application Publications in their entirety: US20170013513A1; US20170026845A1; US20170055186A1; US20170070436A1; US20170077979A1; US20170019375A1; US20170111482A1; US20170048710A1; US20170127409A1; US20170064621A1; US20170202006A1; US20170238278A1; US20170171828A1; US20170181119A1; US20170273134A1; US20170272330A1; US20170208560A1; US20170288813A1; US20170295510A1; US20170303163A1; and US20170257133A1. This application also hereby incorporates by reference U.S. Pat. No. 8,879,416, “Heterogeneous Mesh Network and Multi-RAT Node Used Therein,” filed May 8, 2013; U.S. Pat. No. 9,113,352, “Heterogeneous Self-Organizing Network for Access and Backhaul,” filed Sep. 12, 2013; U.S. Pat. No. 8,867,418, “Methods of Incorporating an Ad Hoc Cellular Network Into a Fixed Cellular Network,” filed Feb. 18, 2014; U.S. patent application Ser. No. 16/827,492, filed Mar. 23, 2020, titled “Diameter Multifold Message”; U.S. patent application Ser. No. 14/034,915, “Dynamic Multi-Access Wireless Network Virtualization,” filed Sep. 24, 2013; U.S. patent application Ser. No. 14/289,821, “Method of Connecting Security Gateway to Mesh Network,” filed May 29, 2014; U.S. patent application Ser. No. 14/500,989, “Adjusting Transmit Power Across a Network,” filed Sep. 29, 2014; U.S. patent application Ser. No. 14/506,587, “Multicast and Broadcast Services Over a Mesh Network,” filed Oct. 3, 2014; U.S. patent application Ser. No. 14/510,074, “Parameter Optimization and Event Prediction Based on Cell Heuristics,” filed Oct. 8, 2014, U.S. patent application Ser. No. 14/642,544, “Federated X2 Gateway,” filed Mar. 9, 2015, and U.S. patent application Ser. No. 14/936,267, “Self-Calibrating and Self-Adjusting Network,” filed Nov. 9, 2015; U.S. patent application Ser. No. 15/607,425, “End-to-End Prioritization for Mobile Base Station,” filed May 26, 2017; U.S. patent application Ser. No. 15/803,737, “Traffic Shaping and End-to-End Prioritization,” filed Nov. 27, 2017, each in its entirety for all purposes, having attorney docket numbers PWS-71700US01, US02, US03, 71710US01, 71721US01, 71729US01, 71730US01, 71731US01, 71756US01, 71775US01, 71865US01, and 71866US01, respectively. This document also hereby incorporates by reference U.S. Pat. Nos. 9,107,092, 8,867,418, and 9,232,547 in their entirety. This document also hereby incorporates by reference U.S. patent application Ser. No. 14/822,839, U.S. patent application Ser. No. 15/828,427, U.S. Pat. App. Pub. Nos. US20170273134A1, US20170127409A1 in their entirety.

### BACKGROUND

Existing Diameter base protocol defined by RFC 6733 provides: delivery of AVPs (attribute value pairs); capabilities negotiation; error notification; extensibility, through addition of new commands and AVPs; and basic services necessary for applications, such as handling of user sessions or accounting.

All data delivered by the protocol is in the form of an AVP. Some of these AVP values are used by the Diameter protocol itself, while others deliver data associated with applications that employ Diameter. AVPs are added arbitrarily to Diameter messages, so long as the required AVPs are included and AVPs that are explicitly excluded are not included. AVPs are used by the base Diameter protocol to support the following required features:

Transporting of user authentication information, for the purposes of enabling the Diameter server to authenticate the user. For example, it can be used by ePDG to authenticate a UE with AAA server.

Transporting of service specific authorization information, between client and servers, allowing the peers to decide whether a user's access request should be granted. For example, MME can check with EIR whether a UE is black listed or not.

Exchanging resource usage information, which is to be used for accounting purposes, capacity planning, etc. For example, PCRF, OCS nodes, etc. talk to PGW for such purpose.

Relaying, proxying and redirecting of Diameter messages through a server hierarchy.

### SUMMARY

A system is disclosed to optimize provisioning of dynamic rules and rule-bases for different subscribers using the same set of rules/rule-bases. This system is also disclosed to optimize dynamic rule installation for a subscriber wishing to install only a subset of rules/rule-base or excluding few rules from those already installed for another subscriber.

In one embodiment, a method is disclosed for providing Diameter charging-rule inheritance support, comprising: provisioning, using an inherit-Charging Rules attribute value pair (AVP), dynamic rules at a Policy Charging and Enforcement Function (PCEF), wherein the inherit-Charging Rules AVP includes an AVP header, an associated session and at least one of a charging rule name, an exclude charging rule name, an exclude charging rule base name, and an AVP; and wherein the AVP inherits policy and charging control (PCC) rule definitions referenced in an Association-Session AVP.

In another embodiment, a non-transitory computer-readable medium containing instructions for providing Diameter charging-rule inheritance support is disclosed. The instructions, when executed, cause a system to perform steps including provisioning, using an inherit-Charging Rules attribute value pair (AVP), dynamic rules at a Policy Charging and Enforcement Function (PCEF), wherein the inherit-Charging Rules AVP includes an AVP header, an associated session and at least one of a charging rule name, an exclude charging rule name, an exclude charging rule base name, and an AVP; and wherein the AVP inherits policy and charging control (PCC) rule definitions referenced in an Association-Session AVP.

In another embodiment, a system is disclosed for providing a Diameter charging-rule inheritance support. The system includes a Policy and Charging Rules Function (PCRF); a Policy Charging and Enforcement Function (PCEF) in communication with the PCRF; and provisioning, using an inherit-Charging Rules attribute value pair (AVP), dynamic rules at a Policy Charging and Enforcement Function (PCEF), wherein the inherit-Charging Rules AVP includes an AVP header, an associated session and at least one of a charging rule name, an exclude charging rule name, an exclude charging rule base name, and an AVP; and wherein the AVP inherits policy and charging control (PCC) rule definitions referenced in an Association-Session AVP.

### BRIEF DESCRIPTION OF THE DRAWINGS

FIG. 1 is a diagram showing a Diameter header format, in accordance with some embodiments.

FIG. 2 is a diagram showing an architecture diagram, in accordance with some embodiments.

FIG. 3 is a call flow diagram, in accordance with some embodiments.

FIG. 4 is a schematic network architecture diagram for 3G and other-G prior art networks.

FIG. 5 is an enhanced eNodeB for performing the methods described herein, in accordance with some embodiments.

FIG. 6 is a coordinating server for providing services and performing methods as described herein, in accordance with some embodiments.

### DETAILED DESCRIPTION

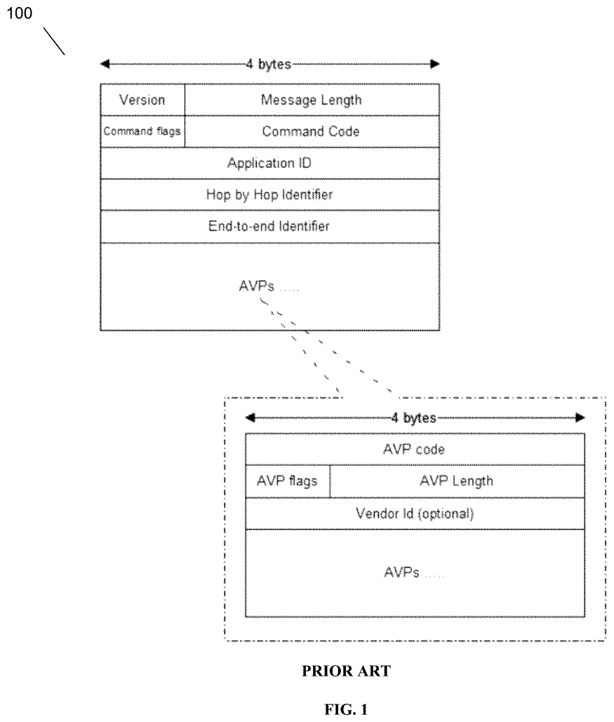

FIG. 1 shows a summary of Diameter header and the AVP structure 100.

The Gx Diameter application uses existing Diameter command codes and AVPs from the Diameter Base Protocol (RFC 6733) and Diameter Credit Control Application (RFC 4006). A Gx reference point is located between the Policy and Charging Rules Function (PCRF) and the Policy and Charging Enforcement Function (PCEF). It is used for provisioning and removal of Policy and Charging Control (PCC) rules from the PCRF to the PCEF and the transmission of traffic plane events from the PCEF to the PCRF. It can be used for charging control, policy control or both by applying Diameter AVPs relevant to the application.

The purpose of the PCC rule is to detect a packet belonging to a service data flow. The service data flow templates within the PCC rule are used for the selection of downlink IP CAN bearers. The service data flow filters within the PCC rule are used for the enforcement that uplink IP flows are transported in the correct IP CAN bearer. Identify the service the service data flow contributes to. Provide applicable charging parameters for a service data flow. Provide policy control for a service data flow.

There are two different types of PCC rules:

Dynamic PCC rules: Dynamically provisioned by the PCRF to the PCEF via the Gx interface. These PCC rules are either predefined or dynamically generated in the PCRF. Dynamic PCC rules can be installed, modified and removed at any time.

Predefined PCC rules: Preconfigured in the PCEF. Predefined PCC rules can be activated or deactivated by the PCRF at any time. Predefined PCC rules within the PCEF are grouped allowing the PCRF to dynamically activate a set of PCC rules over the Gx reference point.

A PCC rule consists of a rule name; service identifier; service data flow filter(s); application identifier; precedence; gate status; QoS parameters; indication for PS to CS session continuity; charging key (i.e. rating group); other charging parameters; monitoring key; sponsor identity; application service provider identity; indication of access network information reporting; and redirect.

To install a PCRF provisioned PCC rule, the PCRF shall provision a corresponding Charging-Rule-Definition AVP within a Charging-Rule-Install AVP.

Charging-Rule-Install AVP (all Access Types)

The Charging-Rule-Install AVP (AVP code 1001) is of type Grouped, and it is used to activate, install or modify PCC rules as instructed from the PCRF to the PCEF.

For installing a new PCC rule or modifying a PCC rule already installed, Charging-Rule-Definition AVP shall be used.

AVP Format: Charging-Rule-Install ::= < AVP Header: 1001 >
*[ Charging-Rule-Definition ]
*[ Charging-Rule-Name ]
*[ Charging-Rule-Base-Name ]
[ Bearer-Identifier ]
[ Rule-Activation-Time ]
[ Rule-Deactivation-Time ]
[ Resource-Allocation-Notification ]
[ Charging-Correlation-Indicator ]
*[ AVP ]

Charging-Rule-Definition AVP (all Access Types)

The Charging-Rule-Definition AVP (AVP code 1003) is of type Grouped, and it defines the PCC rule sent by the PCRF to the PCEF. The Charging-Rule-Name AVP uniquely identifies the PCC rule and it is used to reference to a PCC rule in communication between the PCEF and the PCRF within one IP CAN session.

AVP Format: Charging-Rule-Definition ::= < AVP Header: 1003 >
{ Charging-Rule-Name }
[ Service-Identifier ]
[ Rating-Group ]
*[ Flow-Information ]
[ TDF-Application-Identifier ]
[ Flow-Status ]
[ QoS-Information ]
[ PS-to-CS-Session-Continuity ]
[ Reporting-Level ]
[ Online ]
[ Offline ]
[ Metering-Method ]
[ Precedence ]
[ AF-Charging-Identifier ]
*[ Flows ]
[ Monitoring-Key]
[ Redirect-Information ]
[ Mute-Notification ]
[ AF-Signaling-Protocol ]
[ Sponsor-Identity ]
[ Application-Service-Provider-Identity ]
*[ Required-Access-Info ]
*[ AVP ]

Problem

The PCRF shall indicate, via the Gx reference point, PCC rules to be applied at the PCEF. This is using one of the following procedures:

PULL procedure (Provisioning solicited by the PCEF): In response to a request for PCC rules being made by the PCEF, the PCRF shall provision PCC rules in the CC-Answer; or

PUSH procedure (Unsolicited provisioning): The PCRF decides to provision PCC rules without obtaining a request from the PCEF, or in response to an internal trigger within the PCRF. To provision PCC rules without a request from the PCEF, the PCRF shall include these PCC rules in an RA-Request message.

To install each PCRF-Provisioned PCC rule per IP-CAN session, PCRF needs to send a Diameter Message (RAR or CCA) which includes Charging-Rule-Install AVP defining the PCC rules via Charging-Rule-Definition AVP.

If PCRF wishes to install same list of PCRF-provisioned rules for multiple IP-CAN sessions, it needs to send separate Diameter messages including the entire Rule Definitions for each session.

This messaging seems redundant since these rules are provisioned by PCRF and it has the visibility of the list of rules to be provisioned across various IP-CAN sessions and can optimize if same rule/list of rules need to be provisioned for multiple sessions.

Each Diameter message processing results in processing of L4, L3 and L2 protocols. Significant amount of processing cycles as well as resources are used in processing L2, L3 and L4 layers. If these cycles and resources are saved, it will increase efficiency of the system.

### Solution to Problem

The Diameter protocol is designed to be extensible, using several mechanisms, including: defining new AVPs, creating new AVPs, creating new commands, and creating new applications.

The idea presented in this document extends the Diameter protocol by defining a new vendor specific AVP. To define a new Vendor specific AVP, IETF needs to approve a new RFC which describes the AVP value. The allocation of new AVP value is guided by IANA considerations of document that defines those AVPs.

As per approach suggested in this document, the proposed AVP is defined as follows:

AVP Format: Inherit-Charging-Rules::= < AVP Header >
{Associated-Session}
*[Charging-Rule-Name]
*[Exclude-Charging-Rule-Name]
*[Exclude-Charging-Rule-Base-Name]
*[ AVP ]

The Inherited-Charging-Rules AVP is of type Grouped, and it is used to provision the PCC rules from the PCRF to the PCEF using the reference from the rules already installed for another subscriber. The AVPs inside this grouped AVP are defined as follows:

Associated-Session AVP is a new AVP of the type Subscription-Id AVP (as defined in RFC 4006) and shall be used as the reference for the subscriber from which rule need to be installed for this session.

The Charging-Rule-Name AVP (AVP code 1005) is of type OctetString, and it is used to reference to a PCC rule already installed at PCEF for Associated-Session by PCRF.

The Exclude-Charging-Rule-Name AVP is a new AVP which is of type OctetString, and it is used to reference to a PCC rule which need not be installed while installing all other rules/rulebases referenced from Associated-Session.

The Exclude-Charging-Rule-Base-Name AVP is a new AVP which is of type OctetString, and it is used to reference to a Rule-Base defined at PCEF which need not be installed while installing all other rules/rulebases referenced from Associated-Session.

The Inheritance Strategies are categorized as below:

Wildcard Inheritance

If PCRF wishes to provision same set of rules for a subscriber (M1) which are already installed for another subscriber (M2), it shall send the Re-Auth-Request (RAR) Command or Credit-Control-Answer (CCA) command as a response to Credit-Control-Request (CCR) command including Inherit-Charging-Rules AVP with Associated Session AVP referencing the subscriber M2.

On receiving RAR or CCA command with Inherit-Charging-Rules AVP, PCEF shall fetch the list of all the rules installed for subscriber M1 and install those for subscriber M1.

Wildcard Inheritance with Exception

PCRF can use Exclude-Charging-Rule-Name AVP or Exclude-Charging-Rule-Base-Name AVP inside Inherit-Charging-Rules AVP to exclude installation of specific rules or rulebases.

When PCEF receives Inherit-Charging-Rules AVP along with one or more instances of Exclude-Charging-Rule-Name AVP or Exclude-Charging-Rule-Base-Name AVP, it shall install all the rules installed for subscriber referenced in Associated-Session AVP except the rules specified in Exclude-Charging-Rule-Name AVP and those belonging to the rulebase mentioned in Exclude-Charging-Rule-Base-Name AVP respectively.

Selective Inheritance

If PCRF wishes to provision selective rules which were already installed for another subscriber, it can send Inherit-Charging-Rules AVP including the Associated-Session AVP and the list of rules to be inherited in Charging-Rule-Name AVP.

When PCEF receives Inherit-Charging-Rules AVP along with one or more instances of Charging-Rule-Name AVP, it shall fetch the definition of the rules mentioned in Charging-Rule-Name AVP from the subscriber fetched from Associated-Session AVP and install those for the ongoing session.

This approach will save on L4, L3 and L2 processing for all the subsequent rule installations after a rule has already been installed for another IP-CAN session thus eliminating most part of the stack processing for those messages. This approach increases the overall performance of the system and makes optimal use of resources.

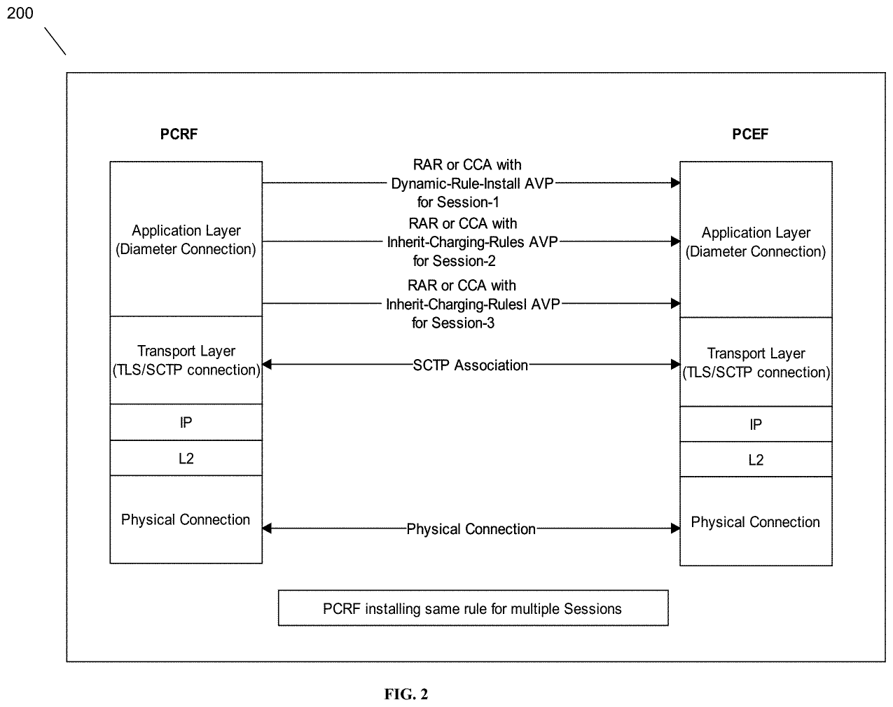

FIG. 2 shows an architecture diagram 200 showing a PCRF installing same rule for multiple sessions. FIG. 2 shows a RAR or CCA with a dynamic-rule-install AVP for a first session; a RAR or CCA with inherit-charging-rules AVP for a second session; and another RAR or CCA with inherit-charging-rules AVP for a third session. The figure shows that a PCRF can install the same rule for multiple sessions. The rule is installed from the PCRF to the PCEF over a Diameter connection at the application layer.

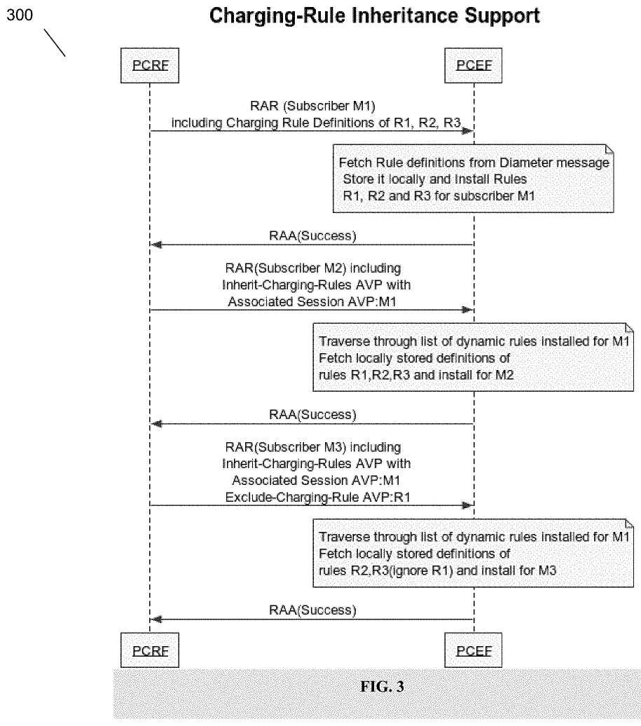

FIG. 3 is a call flow diagram 300 showing charging-rule inheritance support. FIG. 3 shows charging-rule inheritance support for three subscribers, M1, M2, and M3. Rules R1, R2, and R3 are installed from the PCRF to the PCEF at a first time for the first subscriber M1. Subsequently, the definitions of R1, R2, and R3 are fetched from a local store to be installed for subsequent subscribers M2 and M3. The inherit-charging-rules AVP is used to cause the local rules to be installed. The inherit-charging-rules AVP identifies the previously-established session with subscriber M1 as one of its parameters.

It saves on major part of stack processing compared to using Charging-Rule-Install AVP to provision same PCC rule for multiple IP-CAN sessions.

It uses the newly defined Inherit-Charging-Rules AVP to provision the dynamic rules at PCEF. This AVP inherits the PCC rule definitions from the session referenced in Association-Session AVP.

Since PCC rule definitions need not be included in the message being sent by PCRF every time while installing the dynamic rule, this approach significantly reduces the messaging and thus improves the overall performance of the system.

Nodes from Parallel Wireless can interwork with Nodes from other organizations which implement this. This feature can be negotiated during capabilities negotiation.

A new Group Diameter AVP Inherit-Charging-Rules AVP along with AVPs Exclude-Charging-Rule-Name and Exclude-Charging-Rule-Base-Name have been defined using the extensibility feature of Diameter Stack to generate this solution.

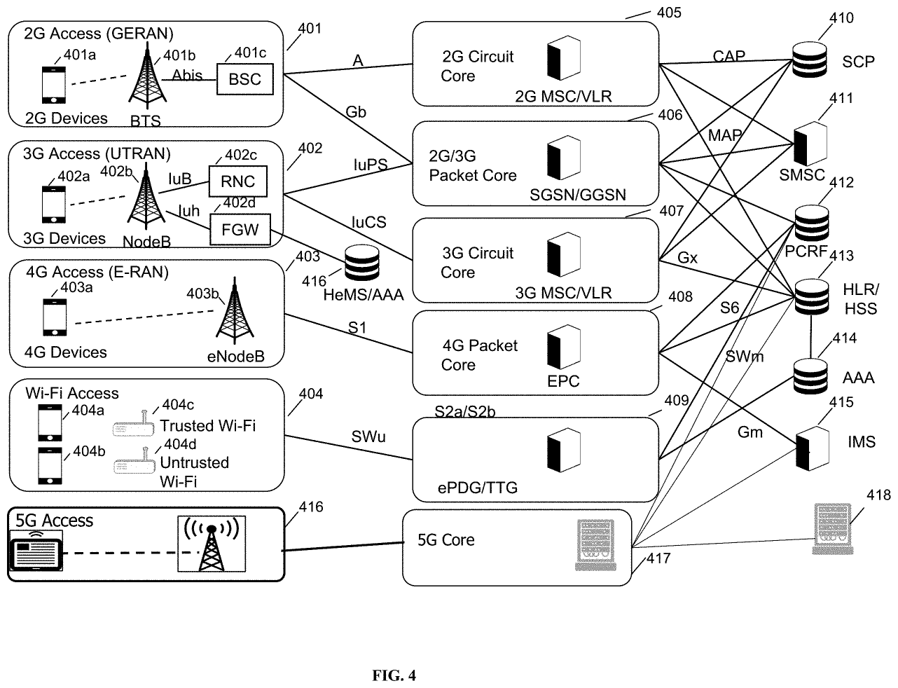

FIG. 4 is a schematic network architecture diagram for 3G and other-G prior art networks. The diagram shows a plurality of “Gs,” including 2G, 3G, 4G, 5G and Wi-Fi. 2G is represented by GERAN 401, which includes a 2G device 401a, BTS 401b, and BSC 401c. 3G is represented by UTRAN 402, which includes a 3G UE 402a, nodeB 402b, RNC 402c, and femto gateway (FGW, which in 3GPP namespace is also known as a Home nodeB Gateway or HNBGW) 402d. 4G is represented by EUTRAN or E-RAN 403, which includes an LTE UE 403a and LTE eNodeB 403b. Wi-Fi is represented by Wi-Fi access network 404, which includes a trusted Wi-Fi access point 404c and an untrusted Wi-Fi access point 404d. The Wi-Fi devices 404a and 404b access either AP 404c or 404d. In the current network architecture, each “G” has a core network. 2G circuit core network 405 includes a 2G MSC/VLR; 2G/3G packet core network 406 includes an SGSN/GGSN (for EDGE or UMTS packet traffic); 3G circuit core 407 includes a 3G MSC/VLR; 4G circuit core 408 includes an evolved packet core (EPC); and in some embodiments the Wi-Fi access network is connected via an ePDG/TTG using S2a/S2b. Each of these nodes are connected via a number of different protocols and interfaces, as shown, to other, non-“G”-specific network nodes, such as the SCP 430, the SMSC 431, PCRF 432, HLR/HSS 433, Authentication, Authorization, and Accounting server (AAA) 434, and IP Multimedia Subsystem (IMS) 435. An HeMS/AAA 436 is present in some cases for use by the 3G UTRAN. The diagram is used to indicate schematically the basic functions of each network as known to one of skill in the art, and is not intended to be exhaustive. For example, 4G core 417 is shown using a single interface to 4G access 416, although in some cases 4G access can be supported using dual connectivity or via a non-standalone deployment architecture.

Noteworthy is that the RANs 401, 402, 403, 404 and 436 rely on specialized core networks 405, 406, 407, 408, 409, 437 but share essential management databases 430, 431, 432, 433, 434, 435, 438. More specifically, for the 2G GERAN, a BSC 401c is required for Abis compatibility with BTS 401b, while for the 3G UTRAN, an RNC 402c is required for Iub compatibility and an FGW 402d is required for Iuh compatibility. These core network functions are separate because each RAT uses different methods and techniques. On the right side of the diagram are disparate functions that are shared by each of the separate RAT core networks. These shared functions include, e.g., PCRF policy functions, AAA authentication functions, and the like. Letters on the lines indicate well-defined interfaces and protocols for communication between the identified nodes.

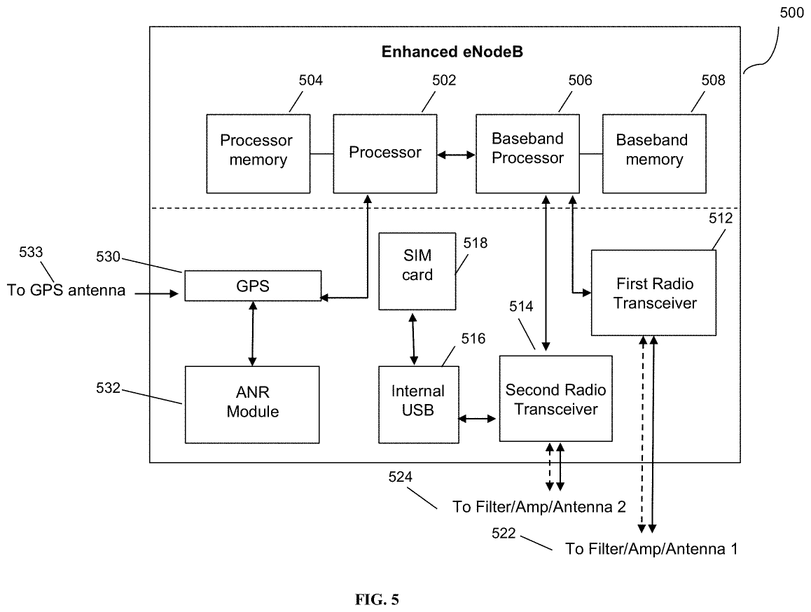

FIG. 5 is an enhanced eNodeB for performing the methods described herein, in accordance with some embodiments. Mesh network node 500 includes processor 502, processor memory 504 in communication with the processor, baseband processor 506, and baseband processor memory 508 in communication with the baseband processor. Mesh network node 500 also includes first radio transceiver 512 and second radio transceiver 514, internal universal serial bus (USB) port 516, and subscriber information module card (SIM card) 518 coupled to USB port 516. In some embodiments, the second radio transceiver 514 itself is coupled to USB port 516, and communications from the baseband processor is passed through USB port 516. The second radio transceiver is used for wirelessly backhauling eNodeB 500.

Processor 502 and baseband processor 506 are in communication with one another. Processor 502 performs routing functions, and determines if/when a switch in network configuration is needed. Baseband processor 506 generates and receives radio signals for both radio transceivers 512 and 514, based on instructions from processor 502. In some embodiments, processors 502 and 506 are on the same physical logic board. In other embodiments, they are on separate logic boards.

Processor 502 identifies the appropriate network configuration, and performs routing of packets from one network interface to another accordingly. Processor 502 uses memory 504, in particular to store a routing table to be used for routing packets. Baseband processor 506 performs operations to generate the radio frequency signals for transmission or retransmission by both transceivers 510 and 512. Baseband processor 506 also performs operations to decode signals received by transceivers 512 and 514. Baseband processor 506 uses memory 508 to perform these tasks.

The first radio transceiver 512 is a radio transceiver capable of providing LTE eNodeB functionality, and is capable of higher power and multi-channel OFDMA. The second radio transceiver 514 is a radio transceiver capable of providing LTE UE functionality. Both transceivers 512 and 514 are capable of receiving and transmitting on one or more LTE bands. In some embodiments, either or both of transceivers 512 and 514 are capable of providing both LTE eNodeB and LTE UE functionality. Transceiver 512 is coupled to processor 502 via a Peripheral Component Interconnect-Express (PCI-E) bus, and/or via a daughtercard. As transceiver 514 is for providing LTE UE functionality, in effect emulating a user equipment, it is also connected via the same or different PCI-E bus, or by a USB bus, and is also be coupled to SIM card 518. First transceiver 512 is coupled to first radio frequency (RF) chain (filter, amplifier, antenna) 522, and second transceiver 514 is coupled to second RF chain (filter, amplifier, antenna) 524.

SIM card 518 provides information required for authenticating the simulated UE to the evolved packet core (EPC). When no access to an operator EPC is available, a local EPC is used, or another local EPC on the network is used. This information is stored within the SIM card, and includes one or more of an international mobile equipment identity (IMEI), international mobile subscriber identity (IMSI), or other parameter needed to identify a UE. Special parameters are stored in the SIM card or provided by the processor during processing to identify to a target eNodeB that device 500 is not an ordinary UE but instead is a special UE for providing backhaul to device 500.

Wired backhaul or wireless backhaul is used. Wired backhaul is an Ethernet-based backhaul (including Gigabit Ethernet), or a fiber-optic backhaul connection, or a cable-based backhaul connection, in some embodiments. Additionally, wireless backhaul is provided in addition to wireless transceivers 512 and 514, which is Wi-Fi 802.11a/b/g/n/ac/ad/ah, Bluetooth, ZigBee, microwave (including line-of-sight microwave), or another wireless backhaul connection. Any of the wired and wireless connections described herein is used flexibly for either access (providing a network connection to UEs) or backhaul (providing a mesh link or providing a link to a gateway or core network), according to identified network conditions and needs, and is under the control of processor 502 for reconfiguration.

A GPS module 530 is also be included, and is in communication with a GPS antenna 532 for providing GPS coordinates, as described herein. When mounted in a vehicle, the GPS antenna is located on the exterior of the vehicle pointing upward, for receiving signals from overhead without being blocked by the bulk of the vehicle or the skin of the vehicle. Automatic neighbor relations (ANR) module 532 is present and is run on processor 502 or on another processor, or is located within another device, according to the methods and procedures described herein.

Other elements and/or modules are also included, such as a home eNodeB, a local gateway (LGW), a self-organizing network (SON) module, or another module. Additional radio amplifiers, radio transceivers and/or wired network connections are included.

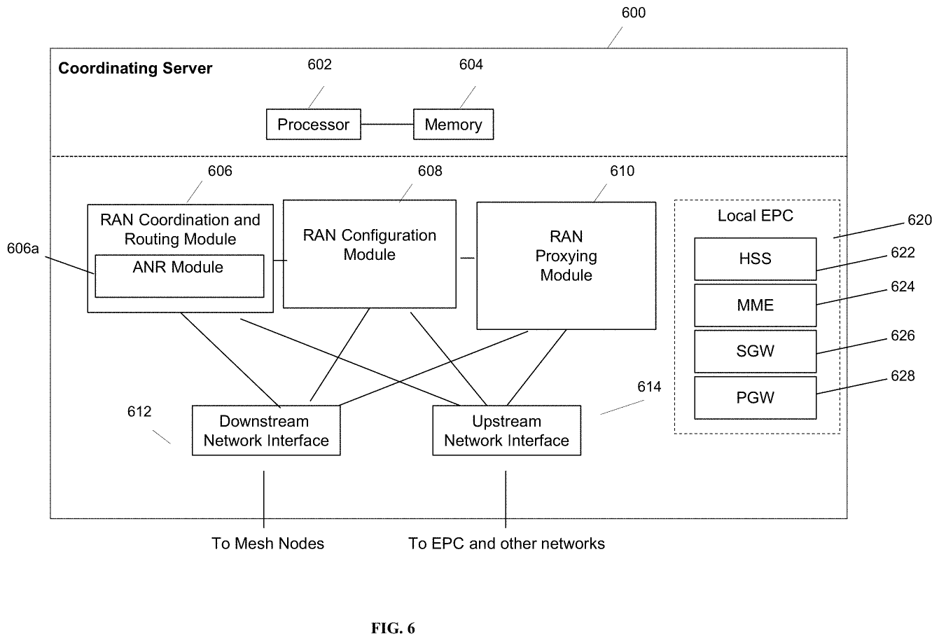

FIG. 6 is a coordinating server for providing services and performing methods as described herein, in accordance with some embodiments. Coordinating server 600 includes processor 602 and memory 604, which are configured to provide the functions described herein. Also present are radio access network coordination/routing (RAN Coordination and routing) module 606, including ANR module 606a, RAN configuration module 608, and RAN proxying module 610. The ANR module 606a performs the ANR tracking, PCI disambiguation, ECGI requesting, and GPS coalescing and tracking as described herein, in coordination with RAN coordination module 606 (e.g., for requesting ECGIs, etc.). In some embodiments, coordinating server 600 coordinates multiple RANs using coordination module 606. In some embodiments, coordination server also provides proxying, routing virtualization and RAN virtualization, via modules 610 and 608. In some embodiments, a downstream network interface 612 is provided for interfacing with the RANs, which is a radio interface (e.g., LTE), and an upstream network interface 614 is provided for interfacing with the core network, which is either a radio interface (e.g., LTE) or a wired interface (e.g., Ethernet).

Coordinator 600 includes local evolved packet core (EPC) module 620, for authenticating users, storing and caching priority profile information, and performing other EPC-dependent functions when no backhaul link is available. Local EPC 620 includes local HSS 622, local MME 624, local SGW 626, and local PGW 628, as well as other modules. Local EPC 620 incorporates these modules as software modules, processes, or containers. Local EPC 620 alternatively incorporates these modules as a small number of monolithic software processes. Modules 606, 608, 610 and local EPC 620 each run on processor 602 or on another processor, or is located within another device.

In any of the scenarios described herein, where processing is performed at the cell, the processing is performed in coordination with a cloud coordination server. A mesh node is an eNodeB. An eNodeB is in communication with the cloud coordination server via an X2 protocol connection, or another connection. The eNodeB performs inter-cell coordination via the cloud communication server when other cells are in communication with the cloud coordination server. The eNodeB communicates with the cloud coordination server to determine whether the UE has the ability to support a handover to Wi-Fi, e.g., in a heterogeneous network.

Although the methods above are described as separate embodiments, one of skill in the art would understand that it would be possible and desirable to combine several of the above methods into a single embodiment, or to combine disparate methods into a single embodiment. For example, all of the above methods could be combined. In the scenarios where multiple embodiments are described, the methods could be combined in sequential order, or in various orders as necessary.

Although the above systems and methods for providing interference mitigation are described in reference to the Long Term Evolution (LTE) standard, one of skill in the art would understand that these systems and methods could be adapted for use with other wireless standards or versions thereof.

The word “cell” is used herein to denote either the coverage area of any base station, or the base station itself, as appropriate and as would be understood by one having skill in the art. For purposes of the present disclosure, while actual PCIs and ECGIs have values that reflect the public land mobile networks (PLMNs) that the base stations are part of, the values are illustrative and do not reflect any PLMNs nor the actual structure of PCI and ECGI values.

In the above disclosure, it is noted that the terms PCI conflict, PCI confusion, and PCI ambiguity are used to refer to the same or similar concepts and situations, and should be understood to refer to substantially the same situation, in some embodiments. In the above disclosure, it is noted that PCI confusion detection refers to a concept separate from PCI disambiguation, and should be read separately in relation to some embodiments. Power level, as referred to above, refers to RSSI, RSFP, or any other signal strength indication or parameter.

In some embodiments, the software needed for implementing the methods and procedures described herein are implemented in a high level procedural or an object-oriented language such as C, C++, C#, Python, Java, or Perl. The software is in assembly language if desired. Packet processing implemented in a network device can include any processing determined by the context. For example, packet processing involves high-level data link control (HDLC) framing, header compression, and/or encryption. In some embodiments, software that, when executed, causes a device to perform the methods described herein are stored on a computer-readable medium such as read-only memory (ROM), programmable-read-only memory (PROM), electrically erasable programmable-read-only memory (EEPROM), flash memory, or a magnetic disk that is readable by a general or special purpose-processing unit to perform the processes described in this document. The processors can include any microprocessor (single or multiple core), system on chip (SoC), microcontroller, digital signal processor (DSP), graphics processing unit (GPU), or any other integrated circuit capable of processing instructions such as an x86 microprocessor.

In some embodiments, the radio transceivers described herein are base stations compatible with a Long Term Evolution (LTE) radio transmission protocol or air interface. The LTE-compatible base stations are eNodeBs. In addition to supporting the LTE protocol, the base stations also support other air interfaces, such as UMTS/HSPA, CDMA/CDMA2000, GSM/EDGE, GPRS, EVDO, other 3G/2G, 5G, legacy TDD, or other air interfaces used for mobile telephony. 5G core networks that are standalone or non-standalone have been considered by the inventors as supported by the present disclosure.

In some embodiments, the base stations described herein support Wi-Fi air interfaces, which also include one or more of IEEE 802.11a/b/g/n/ac/af/p/h. In some embodiments, the base stations described herein support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols including 5G, or other air interfaces.

The foregoing discussion discloses and describes merely exemplary embodiments of the present invention. In some embodiments, software that, when executed, causes a device to perform the methods described herein are stored on a computer-readable medium such as a computer memory storage device, a hard disk, a flash drive, an optical disc, or the like. As will be understood by those skilled in the art, the present invention is embodied in other specific forms without departing from the spirit or essential characteristics thereof. For example, wireless network topology can also apply to wired networks, optical networks, and the like. The methods apply to LTE-compatible networks, to UMTS-compatible networks, to 5G networks, or to networks for additional protocols that utilize radio frequency data transmission. Various components in the devices described herein are added, removed, split across different devices, combined onto a single device, or substituted with those having the same or similar functionality.

Although the present disclosure has been described and illustrated in the foregoing example embodiments, it is understood that the present disclosure has been made only by way of example, and that numerous changes in the details of implementation of the disclosure are made without departing from the spirit and scope of the disclosure, which is limited only by the claims which follow. Various components in the devices described herein are added, removed, or substituted with those having the same or similar functionality. Various steps as described in the figures and specification are added or removed from the processes described herein, and the steps described are performed in an alternative order, consistent with the spirit of the invention. Features of one embodiment are used in another embodiment. Other embodiments are within the following claims.

1. A method for providing Diameter charging-rule inheritance support, comprising:
provisioning, using an inherit-Charging Rules attribute value pair (AVP), dynamic rules at a Policy Charging and Enforcement Function (PCEF), wherein the inherit-Charging Rules AVP includes an AVP header, an associated session and at least one of a charging rule name, an exclude charging rule name, an exclude charging rule base name, and an AVP; and
wherein the AVP inherits policy and charging control (PCC) rule definitions referenced in an Association-Session AVP.

2. The method of claim 1 further comprising using the inherit-Charging-Rules AVP for provisioning the PCC rules from a Policy and Charging Rules Function (PCRF) to the PCEF using the reference from the rules already installed for another subscriber.

3. The method of claim 1 further comprising using the Associated-Session as a reference for a subscriber from which rule needs to be installed for this session.

4. The method of claim 1 further comprising using the Charging-Rule-Name to reference to a PCC rule already installed at PCEF for Associated-Session by the PCRF.

5. The method of claim 1 further comprising using the Exclude-Charging-Rule-Name to reference to a PCC rule which need not be installed while installing all other rules/rulebases referenced from Associated-Session.

6. The method of claim 1 further comprising using the Exclude-Charging-Rule-Base-Name to reference to a Rule-Base defined at the PCEF which need not be installed while installing all other rules/rulebases referenced from Associated-Session.

7. A non-transitory computer-readable media containing instructions for providing Diameter charging-rule inheritance support which, when executed, cause a system to perform steps comprising:
provisioning, using an inherit-Charging Rules attribute value pair (AVP), dynamic rules at a Policy Charging and Enforcement Function (PCEF), wherein the inherit-Charging Rules AVP includes an AVP header, an associated session and at least one of a charging rule name, an exclude charging rule name, an exclude charging rule base name, and an AVP; and
wherein the AVP inherits policy and charging control (PCC) rule definitions referenced in an Association-Session AVP.

8. The computer-readable media of claim 7 further comprising instructions for using the inherit-Charging-Rules AVP for provisioning the PCC rules from a Policy and Charging Rules Function (PCRF) to the PCEF using the reference from the rules already installed for another subscriber.

9. The computer-readable media of claim 7 further comprising instructions for using the Associated-Session as a reference for a subscriber from which rule needs to be installed for this session.

10. The computer-readable media of claim 7 further comprising instructions for using the Charging-Rule-Name to reference to a PCC rule already installed at PCEF for Associated-Session by the PCRF.

11. The computer-readable media of claim 7 further comprising instructions for using the Exclude-Charging-Rule-Name to reference to a PCC rule which need not be installed while installing all other rules/rulebases referenced from Associated-Session.

12. The computer-readable media of claim 7 further comprising instructions for using the Exclude-Charging-Rule-Base-Name to reference to a Rule-Base defined at the PCEF which need not be installed while installing all other rules/rulebases referenced from Associated-Session.

13. A system for providing Diameter charging-rule inheritance support, comprising:
a Policy and Charging Rules Function (PCRF);
a Policy Charging and Enforcement Function (PCEF) in communication with the PCRF; and
provisioning, using an inherit-Charging Rules attribute value pair (AVP), dynamic rules at a Policy Charging and Enforcement Function (PCEF), wherein the inherit-Charging Rules AVP includes an AVP header, an associated session and at least one of a charging rule name, an exclude charging rule name, an exclude charging rule base name, and an AVP; and
wherein the AVP inherits policy and charging control (PCC) rule definitions referenced in an Association-Session AVP.

14. The system of claim 13 further comprising using the inherit-Charging-Rules AVP for provisioning the PCC rules from a Policy and Charging Rules Function (PCRF) to the PCEF using the reference from the rules already installed for another subscriber.

15. The system of claim 13 further comprising using the Associated-Session as a reference for a subscriber from which rule needs to be installed for this session.

16. The system of claim 13 further comprising using the Charging-Rule-Name to reference to a PCC rule already installed at PCEF for Associated-Session by the PCRF.

17. The system of claim 13 further comprising using the Exclude-Charging-Rule-Name to reference to a PCC rule which need not be installed while installing all other rules/rulebases referenced from Associated-Session.

18. The system of claim 13 further comprising using the Exclude-Charging-Rule-Base-Name to reference to a Rule-Base defined at the PCEF which need not be installed while installing all other rules/rulebases referenced from Associated-Session.
